(19) United States
(12) Patent Application Publication
(10) Pub. No.: US 2008/0249777 A1
(43) Pub. Date: Oct. 9, 2008

(54) Method And System For Control Of An Application

(75) Inventors: Eric Thelen, Aachen (DE); Holger R. Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/568,406

(22) PCT Filed: Apr. 20, 2005
(86) PCT No.: PCT/IB2005/051294

§ 371 Date: Oct. 27, 2006

(30) Foreign Application Priority Data
Apr. 29, 2004 (EP) 04101823.5

(51) Int. Cl. G10L 11/00; G06F 3/033

(52) U.S. Cl. 704/270; 345/157

(57) ABSTRACT

The invention describes a dialog management system and method for control of an application (A₁, A₂, . . . , Aₙ). The dialog management system (1) for controlling an application (A₁, A₂ . . . , Aₙ) comprises a mobile pointing device comprising a camera for generating an image (22, 23, 31) of a target area in the direction (D) in which the mobile pointing device (2) is aimed and a transmission interface (4ₐ, 4_{b}) for transmitting the target area image (22, 23, 31) to a local interaction device (7). The local interaction device (7) comprises an audio interface arrangement (5) for detecting and processing speech input and generating and outputting audible prompts, a core dialog engine (11) for coordinating a dialog flow by interpreting user input and generating output prompts, an application interface (12) for communication between the dialog management system (1) and the application (A₁, A₂, . . . , Aₙ), a receiving interface (13ₐ, 13_{b}) for receiving the target area image (22, 23, 31) from the mobile pointing device (2) and an image processing arrangement (14) for processing the target area image (22, 23, 31).

This invention relates to a dialog management system and a method for driving a dialog management system for remote control of an application. Moreover, the invention relates to a local interaction device and a pointing device for such a speech dialog system.

Remote controls are used today together with almost any consumer electronics device, e.g. television, DVD player, tuner, etc. In the average household, multiple remote controls—often one for each consumer electronics device—can be required. Even for a person well acquainted with the consumer electronics devices he owns, it is a challenge to remember what each button on each remote control is actually for. Furthermore, the on-screen menu-driven navigation available for some consumer electronics devices is often, less than intuitive, particularly for users that might not possess an in-depth knowledge of the options available for the device. The result is that the user must continually examine the menu presented on the screen to locate the option he is looking for, and then look down at the remote control to search for the appropriate button. Quite often the buttons are given non-intuitive names or abbreviations. Additionally, a button on the remote control might also perform a further function, which is accessed by first pressing a mode button. The multitude of options available for modern consumer electronics devices unfortunately mean that for many users, programming such a device can become an exercise in frustration. The large number of buttons and non-intuitive menu options can make the programming of a device more difficult than necessary and often result in the user not getting the most out of the devices he has bought.

Using all one's consumer electronics devices to the full is made even more difficult by the fact that almost every consumer electronics device today comes with its own remote control device. Whilst most remote control button abbreviations and symbols are by now standardised to allow marketing of the same remote control device in countries of different languages, even so it might be that different abbreviations or symbols are used on different remote controls to perform the same function, for example the abbreviation “CH” and “PR” might be used to indicate “channel” or “program”, meaning essentially the same thing. The remote controls also differ in shape, size, overall appearance and even battery requirements.

In an effort to reduce the confusion caused by such a multitude of remote controls, a new product category of “universal remote controls” has been developed. However, even a universal remote control cannot hope to access all the functions offered by every consumer electronics device available on the market today, particularly since new technologies and features are continually being developed. Furthermore, the wide variety of functions offered by modern consumer electronics devices necessitates a correspondingly large number of buttons to invoke these functions, requiring an inconveniently large remote control to accommodate all the buttons.

Furthermore, a typical remote control is limited to controlling one or at most a small number of similar devices, all of which must be equipped with compatible interfaces, e.g. one remote control can at best be used for television, CD player and VCR, and it can do this only when in the vicinity of the devices to be controlled. If the user takes the remote control out of reach of the devices, he can no longer control their function.

Other methods of controlling devices or applications, for example by means of a spoken dialog between the user and a dialog management system, are known. Sometimes, such a dialog management system can communicate in some way with an application, so that the user can control the application indirectly by speaking appropriate commands to the dialog management system, which interprets the spoken commands and communicates the commands to the application accordingly. However, such a dialog management system is limited to an entirely speech-based communication; i.e. the user must utter clear commands which have unique interpretations for the applications to be controlled. The user must learn all these commands, and the dialog management system may have to be trained to recognise them also. Furthermore, use of these methods is usually limited to scenarios where the user is in the vicinity of the dialog management system. Control of the applications is therefore constrained by the whereabouts of the user.

Therefore, an object of the present invention is to provide a method and system for convenient and intuitive remote control by the user of an application.

To this end, the present invention provides a dialog management system for controlling an application, comprising a mobile pointing device and a local interaction device. The mobile pointing device comprises a camera and is capable of generating an image of a target area in the direction in which the mobile pointing device is aimed, and can transmit the target area image by means of a transmission interface to the local interaction device in a wireless manner, for example using Bluetooth or 802.11b standards. The local interaction device in turn comprises an audio interface arrangement for detecting and processing speech input and generating and outputting audible prompts, and a core dialog engine for coordinating a dialog flow by interpreting user input and generating output prompts. Furthermore, the local interaction device comprises an application interface for communication between the dialog management system and the application, which can preferably deal with several applications in a parallel manner, as well as a receiving interface for receiving target area images from the mobile pointing device, and an image processing arrangement for processing the target area image. The dialog management system might preferably control a number of applications running in a home and/or office environment, and might inform the user of their status.

The “target area” is understood to mean the area in front of the mobile pointing device which can be recorded in an image by the camera of the device. The size of the target area might largely be determined by the capabilities of the camera incorporated in the mobile pointing device. To generate an image, the user might point the mobile pointing device at the front of a device, at a page of a newspaper or magazine, or at any object he wishes to photograph. For the sake of simplicity, the target at which the mobile pointing device is being aimed is termed “visual presentation” in the following. The term “target area image” is to be understood in the broadest possible sense, for example the target area image might comprise merely image data concerning significant points of the entire image, e.g. enhanced contours, corners, edges etc.

A local interaction device according to the present invention might be incorporated in an already existing device such as a PC, television, video recorder etc. In a preferred embodiment, the local interaction device is implemented as a stand-alone device, with a physical aspect such as that of a robot or preferably a human. The local interaction device might be realised as a dedicated device as described, for example, in DE 10249060 A1, constructed in such a way that a moveable part with schematic facial features can turn to face the user, giving the impression that the device is listening to the user. Such a local interaction device might even be constructed in such a fashion that it can accompany the user as he moves from room to room. The interfaces between the local interaction device and the individual applications might be realised by means of cables. Preferably, the interfaces are realised in a wireless manner, such as infra-red, Bluetooth, etc., so that the local interaction device remains essentially mobile within its allocated environment, and is not restricted to being positioned in the immediate vicinity of the applications which it is used to drive. If the wireless interfaces have sufficient reach, the local interaction device of the dialog management system can easily be used for controlling numerous applications for devices located in different rooms of a building, such as an office block or private house. The interfaces between the local interaction device and the individual applications are preferably managed in a dedicated application interface unit. Here, the communication between the applications and the local interaction device is managed by forwarding to each application any commands or instructions interpreted from the spoken user input, and by receiving from an application any feedback intended for the user. The application interface unit can deal with several applications in a parallel manner. In a particularly preferred embodiment of the invention, the local interaction device comprises an automatically directable front aspect which is directed to face the user during presentation of a dialog prompt, during presentation of the user options for an application to be controlled, or during presentation of an image or audio message to the user.

A method according to the invention for driving such a dialog management system for controlling an application or a device by spoken dialog comprises an additional step, where appropriate, of aiming a mobile pointing device at a specific object and generating an image of a target area by means of a camera integrated in some way in the mobile pointing device. The image of the target area is subsequently transmitted to a local interaction device of the dialog management system where it is processed in order to derive control information for controlling the device or application.

The method and the system thus provide a comfortable way for a user to interact with an application by simply aiming a compact hand-held mobile pointing device at a visual presentation to generate an image of at least part of the visual presentation, and transmitting this image to the local interaction device, which can interpret the image and communicate as appropriate with the corresponding application or device. The user is therefore no longer limited to a speech dialog or to a predefined set of commands, but can communicate in a more natural manner by pointing out an object or pointing at a visual presentation, for example to augment a spoken command.

The dependent claims and the subsequent description disclose particularly advantageous embodiments and features of the invention.

The local interaction device can, as mentioned already, be used to communicate with a single application, but might equally be used to control a plurality of different applications. An application can be a simple function such as a translation program, a store-cupboard manager or any other database, or might be an actual device such as a TV, a DVD player or refrigerator. The mobile pointing device can thus be used as a remote control for one application or for a plurality of applications. Furthermore, a number of mobile pointing devices can be assigned to a local interaction device, so that, for example, each member of a household has his own mobile pointing device. On the other hand, one mobile pointing device might be assigned to a number of local interaction devices in different environments, for example so that a user might use his mobile pointing device for controlling applications at home as well as in a different location such as the office.

User options for controlling an application can be presented to the user in a number of ways, both static and dynamic. Options can be acoustically presented to the user by means of the speech dialog, so that the user can listen to the options and verbally specify the desired option. On the other hand, options can equally well be presented visually. The simplest visual presentation of the user options for a device in static form is the front of the device itself, where various options are available in the form of buttons or knobs, for example the stop, fast forward, record and play buttons on a VCR. Another example of a static visual presentation might be to show the user options in printed form, for example as a computer printout, or a program guide in a TV magazine. Especially for a device such as a TV, or DVD player which can be connected to a television, the options may be available to the user in static form as buttons on the front of the device, and can also easily be dynamically displayed on the television screen. Here, the options might be shown in the form of menu items or as icons. In a particularly preferred embodiment of the invention, user options for more than one device can be shown simultaneously in one visual presentation. For example, tuner options and DVD options might be displayed together, particularly options that are relevant to both devices. One example of such a combination of options might be to display a set of tuner audio options such as surround sound, Dolby etc, along with DVD options such as wide screen, sub-titles etc. The user can thus easily and quickly customise the options for both devices.

In a preferred embodiment of the invention, the local interaction device might be connected to a projector which can project visual presentations of user options for a number of applications, in the form of an image backdrop onto a suitable surface, for example a wall. The local interaction device might also avail of a separate screen, or might use a screen of one of the applications to be controlled. In this way, user options can be presented in a comfortable manner for an application which does not otherwise feature a display, for example a store-cupboard management application. Equally, any options of a device represented by buttons on the front of a device can, for example, be presented as menu options on the larger image backdrop for ease of selection. In a further preferred embodiment of the invention, the local interaction device can produce a hard-copy of a visual presentation, for example it can print out a list of up-coming programs with associated critic's reports, or it can print out a recipe for a meal that the user can prepare using products available in the user's store-cupboard.

Additionally, the invention might easily provide the user with a means of personalizing the options for the device, for example by only displaying a small number of options on the screen at one time, for example to assist a user with poor vision. Further, the user might specifically choose to omit functions that he is unlikely ever to require, for example, for his DVD player, he might never wish to view a film accompanied by foreign-language subtitles. In this case, he can personalize his user interface to omit these options from the visual presentation. A device such as a television can be configured so that for some users, only a subset of the available options is accessible. In this way, certain channels can be made accessible only by authorised users, for example to protect children from watching programs unsuitable to their age group.

The visual presentation can be used to augment a speech dialog, for example, by allowing the user to verbally specify or choose an option from a number of options presented visually. By means of the mobile pointing device according to the invention, the user can advantageously also choose among the options available by aiming a mobile pointing device containing a camera at the visual presentation of the user options.

The camera is preferably incorporated in the mobile pointing device but might equally be mounted on the mobile pointing device, and is preferably oriented in such a way that it generates images of the area in front of the mobile pointing device targeted by the user. The image of the target area might be only a small subset of the entire visual presentation, it might cover the visual presentation in its entirety, or it might also include an area surrounding the visual presentation. The size of the target area image in relation to the entire visual presentation might depend on the size of the visual presentation, the distance between the mobile pointing device and the presentation, and on the capabilities of the camera itself. The user might be positioned so that the mobile pointing device is at some distance from the visual presentation. Equally, the user might hold the mobile pointing device quite close to the visual presentation, as might arise when the user is aiming the mobile pointing device at a TV program guide in magazine form.

In a preferred embodiment of the invention, a light source might be mounted in or on the mobile pointing device. The light source might serve to illuminate the area at which the mobile pointing device is aimed, in the manner of a flashlight, so that the user can easily peruse the visual presentation even if the surroundings are dark. Equally, the light source might be a source of a concentrated beam of light emitted in the direction of pointing, so that a point of light appears at or near the target point on the visual presentation at which the user is aiming, providing visual positional feedback to help the user aim at the desired option. A simple realisation might be a laser light source incorporated in or mounted on the mobile pointing device in an appropriate manner. In the following therefore, it is assumed—without limiting the invention in any way—that the source of concentrated light is a laser beam.

The pointing device might be aimed by the user at a particular option in a visual presentation, for example at the play button on the front of a VCR device, at a DVD option displayed on a TV screen, or at a particular program in a TV magazine. To indicate that a selection is being made, the user might move the pointing device in a pre-defined manner over the visual presentation, for example by describing a loop or circular shape around the desired option. The user might move the pointing device through the air at a distance removed from visual presentation, or might move the pointing device directly over or very close to the visual presentation. Another way of indicating a particular option selection might be to aim the pointing device steadily at the option for a pre-defined length of time. Equally, the user might flick the pointing device across the visual presentation to indicate, for example, a return to normal program viewing after removing a visual presentation from a screen of a TV device being used by the local interaction device for a dynamic visual presentation, or to return to a previous menu level. The movement of the pointing device relative to the visual presentation might preferably be detected by the image processing unit of the local interaction device, or might be detected by a motion sensor in the pointing device. A further possibility might be to press a button on the pointing device to indicate selection of the option at which the pointing device is aimed. In a preferred embodiment, the core dialog engine can initiate a verbal confirmation dialog in order to ascertain that it has correctly interpreted the user's actions, for example if the user has aimed at a point considerably removed from the optical centre of an option while pressing the button or moving the pointing device in a pre-defined manner. In this case the core dialog engine might request confirmation before proceeding to initiate the selected option or function.

If the visual presentation is of a dynamic nature, the dialog management system can preferably cause the local interaction device to alter the visual presentation to highlight the selected option in some way, for example by making the option appear to flash or by highlighting the region in the visual presentation aimed at by the user, and perhaps accompanying this by an audible “click” sound. The mobile pointing device might also select a function in the visual presentation using a “drag and drop” technique, particularly when the user must navigate through larger content spaces, for example by dragging an icon representing buffered DVD movie data to another icon representing a trash can, thus indicating that the buffered data be deleted from memory. Various functions might be initiated by the user, whereby the user selects the option in a manner similar to a “double-click”, for example, by repeating the motion of the mobile pointing device in the pre-defined manner, or twice pressing a button on the mobile pointing device.

To determine which option has been selected by the user, the image processing arrangement may compare the received target area images to, for example, a number of pre-defined templates of the visual presentation. A single pre-defined template might suffice for the comparison, or it may be necessary to apply more than one template in order to make a successful comparison.

Pre-defined templates can be stored in an internal memory, or might equally be accessed from an external source. Preferably, the control unit comprises an accessing unit with an appropriate interface for obtaining pre-defined templates for the visual presentation of the device to be controlled from, for example, an internal or external memory, a memory stick, an intranet or the internet. A template can be a graphical representation of the front of the device to be controlled, for example a simplified representation of the front of a VCR device featuring the user options available, for example the buttons representing the play, fast-forward, rewind, stop and record functions. A template can also be a graphical representation of an options menu as displayed on a TV screen and might indicate the locations of the available device options associated with particular areas of the visual presentation. For example, the user options for a DVD player such as play, fast-forward, sub-titles, language etc., can also be visually presented on the TV screen. The template can also depict the area around the visual presentation, for example it may include the housing of the device, and may even include some of the immediate surroundings of the device.

User options for a device which can display these on a screen can often be presented in the form of menus, where the user can traverse the menus to arrive at the desired option or function. In a preferred embodiment of the invention, a template exists for each possible menu level for the device to be controlled, so that the user can aim the mobile pointing device at any one of the available options at any level of control of the device. Another type of template might have the appearance of a TV program guide in a magazine. Here, templates for the layout of the pages in the TV guide might be obtained and/or updated by the accessing unit, for example on a daily or weekly basis. Preferably, the image interpretation software is compatible with the format of the TV guide pages. The templates preferably feature the positions on the pages of the various program options available to the user. The user might aim the mobile pointing device over the visual presentation in the form of a page in an actual TV program guide to select a particular option, or the guide might be visually presented on the TV screen at which the user can aim the mobile pointing device to choose between the options available.

Other templates might be depictions of known products, for example for an application such as a store-cupboard manager. Here, the templates might represent products that the user prefers to buy and consume. The user might obtain templates of all the products to be managed, for example by downloading images from the internet, or by photographing the objects with his mobile pointing device and transferring the images to the local interaction device, where they are processed and furthered to the store-cupboard management application where they can serve as templates for comparison with images which the user might transmit to the local interaction device at a later point in time.

For processing the target area image in order to determine the chosen option, it is expedient to apply computer vision techniques to find the point in the visual presentation at which the user has aimed, i.e. the target point.

In a preferred embodiment of the invention, a fixed point in the target area image, preferably the centre of the target area image, obtained by extending an imaginary line in the direction of the longitudinal axis of the mobile pointing device to the visual presentation, might be used as the target point.

A method of processing the target area images of the visual presentation using computer vision algorithms might comprise detecting distinctive points in the target image and determining corresponding points in the template of the visual presentation, and developing a transformation for mapping the points in the target image to the corresponding points in the template. The distinctive points of the target area image might be points of the visual presentation, or might equally be points in the area surrounding the visual presentation, for example the corners of a television screen, or points belonging to an object in the vicinity of the device to be controlled and which are also recorded in the pre-defined templates. This transformation can then be used to determine the position and aspect of the mobile pointing device relative to the visual presentation so that the intersection point of an axis of the mobile pointing device with the visual presentation can be located in the template. The position of this intersection in the template corresponds to the target point on the visual presentation, and can be used to easily determine which of the options has been targeted by the user. The position of the target point in the pre-defined template indicates the option selected by the user. In this way, comparing the target area image with the pre-defined template is restricted to identifying and comparing only salient points such as distinctive corner points. The term “comparing” as applicable in this invention is to be understood in a broad sense, i.e. by only comparing sufficient features in order to quickly identify the point at which the user is aiming.

Another possible way of determining the option selected by the user is to directly compare the received target area image, centred around the target point, with a pre-defined template to locate the point targeted in the visual presentation using methods such as pattern-matching. Another way of comparing the target area image with the pre-defined template restrict itself to identifying and comparing only salient points such as distinctive corner points.

In a further embodiment of the invention, the location of the laser point, transmitted to the receiver in the control unit as part of the target area image, might be used as the target point to locate the option selected by the user. The laser point may be superimposed on the centre of the target area image, but might equally well be offset from the centre of the target area image.

In a preferred embodiment of the invention, the mobile pointing device can be in the shape of a wand or pen in an elongated form that can be grasped comfortably by the user. The user can thus direct the mobile pointing device at a target point in the visual presentation while positioned at a comfortable viewing distance from it. Equally, the mobile pointing device might be shaped in the form of a pistol.

In a particularly preferred embodiment of the invention, the mobile pointing device and the local interaction device comprise mutual interfaces for long distance transmission and/or reception of speech and media data over a communication network allowing a user to communicate with and control an application, without him having to be anywhere near the vicinity of the application. In a particularly economical embodiment of the invention however, the mobile pointing device is incorporated in or connectable to a portable device such as a mobile telephone. Using such an already existing type of device provides an economical and intuitive way to provide a means for transmitting speech and other media data over any kind of communication network. Verbal commands or descriptive remarks can be spoken into the mobile pointing device to accompany a target area image when being transmitted to the local interaction device, or can be transmitted independently to the local interaction device. For example, if the user is shopping in a supermarket, he might send an image of a particular product to the local interaction device, and accompany it with the query “Do I have any of this at home?”. After checking with a store-cupboard management application, the local interaction device can transmit the reply to the mobile pointing device, which then informs the user if he has any of the product in question at home, or whether he needs to buy some more.

The mobile pointing device might be aimed by the user at any particular object of interest to the user or applicable to control of an application. For example, the user might aim it at an article in a magazine if he has spotted something of interest that he would like to look at later on. This feature might be particularly useful in situations where the user is away from home and cannot deal with the information at once. For example, he might have seen that a particular program is scheduled in the near future, but he is due home too late to program his VCR to record the program. In this case, he might aim the mobile pointing device at the area on the page containing the relevant information regarding the program and generate an image. The user then initiates transmission of the target area image to the local interaction device. He might choose to accompany the image with a written text such as an SMS, or he might send a spoken message such as “Record this program”. The local interaction device processes the image to extract the relevant information regarding the program, and interprets the accompanying message to send the appropriate commands to the relevant device.

Nevertheless, in some situations, the user may not wish to transmit the images to the local interaction device right away, for example if the target area images can be processed at a later point in time, or if the user would like to avoid the costs of transmission over a mobile telecommunication network. To this end, the mobile pointing device might comprise a memory for temporary storage of target area images. The memory might be in the form of a smart card which can be inserted or removed as required, or it might be in the form of a built-in memory. In a preferred embodiment of the invention, the mobile pointing device comprises a suitable interface for loading images into the memory of the mobile pointing device. An example of such an interface might be USB. This allows the user to load images of interest from another source onto his mobile pointing device. He can then transmit them to the local interaction device right away or at a later point in time.

The invention thus provides, in all, an easy and flexible way to manage large collections of items, such as store-cupboard products or books. Quite often, a collection of books is distributed about the home in a number of rooms and shelves. With the aid of the mobile pointing device, the user can point at a particular book and utter certain words to the local interaction device to identify the book. The mobile pointing device generates an image of the book, most usually the spine of the book since this is all that is visible when the book is tidied away on a shelf. The user might point at a number of books and generate images for each one. The user might cause the images to be stored in the mobile pointing device, or might allow each to be transmitted over the most suitable interface to the local interaction device. When the user has finished gathering all the required images for the books, he speaks appropriate words to the local interaction device, corresponding to an image. For example, for the picture of the spine of “Huckleberry Finn”, he says “The book ‘Huckleberry Finn’ is on the shelf in the children's room”. Similarly, he might say “The book ‘Physics for Dummies’ is on the bottom shelf in the study” or “‘War and Peace’ is on the shelf next to the window in the living room” to identify the corresponding books. The local interaction device associates the spoken words with the images and stores them in an appropriate manner in a memory. At a later date, if the user or another person wants to locate a book, all they have to do is ask “Where is the book ‘War and Peace’?”, and the local interaction device will reply “You will find it on the shelf next to the window in the living room”. To further aid localisation of the object, the local interaction device might also display on a screen the image that the user originally made with the mobile pointing device, so that the object can easily and quickly be found.

Not only books can be managed in this way, since the method is applicable to practically any item. Particularly items such as passports, birth certificates etc., that are not often required and whose whereabouts are therefore easily forgotten can be located in this way. Thus, a collection of all kinds of items can be managed to allow users to easily locate any of the items. With the mobile pointing device and the local interaction device, the user can easily train an application to record the whereabouts of any item. The dialog management system can also be used to train an application to recognise items or objects on the basis of their appearance, to simplify decision processes, for example in putting together a shopping list. The user might, for example, aim the mobile pointing device at various products in turn in his store-cupboard, generate images for each of the objects, and accompany the images with appropriate descriptive comments such as “This is my favorite breakfast cereal”, or “Don't ever put this kind of coffee on the shopping list again”, etc.

Other objects and features of the present invention will become apparent from the following detailed descriptions considered in conjunction with the accompanying drawing. It is to be understood, however, that the drawings are designed solely for the purposes of illustration and not as a definition of the limits of the invention.

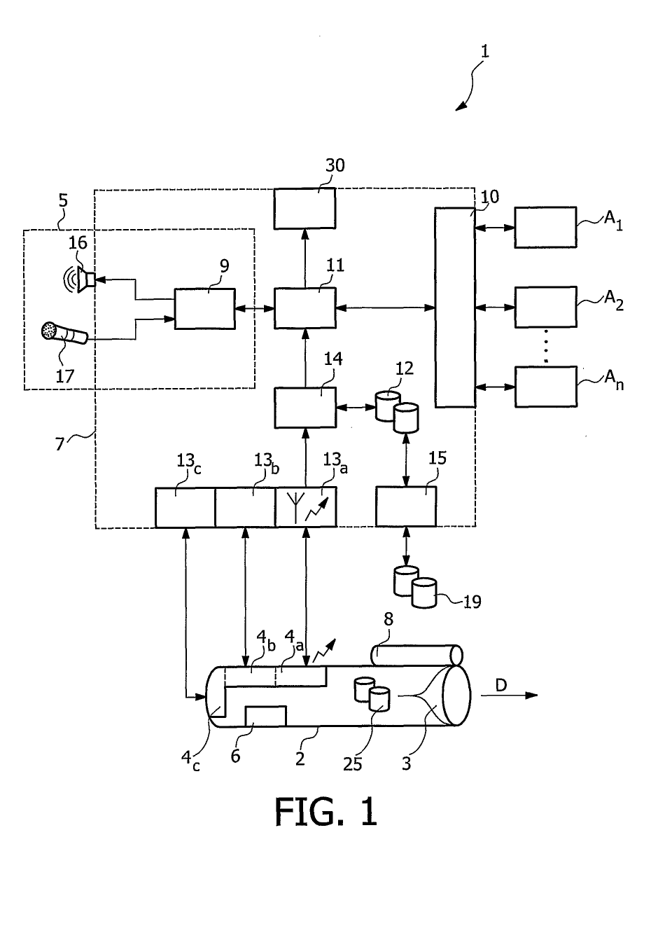

FIG. 1 is a block diagram showing a local interaction device, a mobile pointing device, and the interfaces between them in accordance with an embodiment of the present invention;

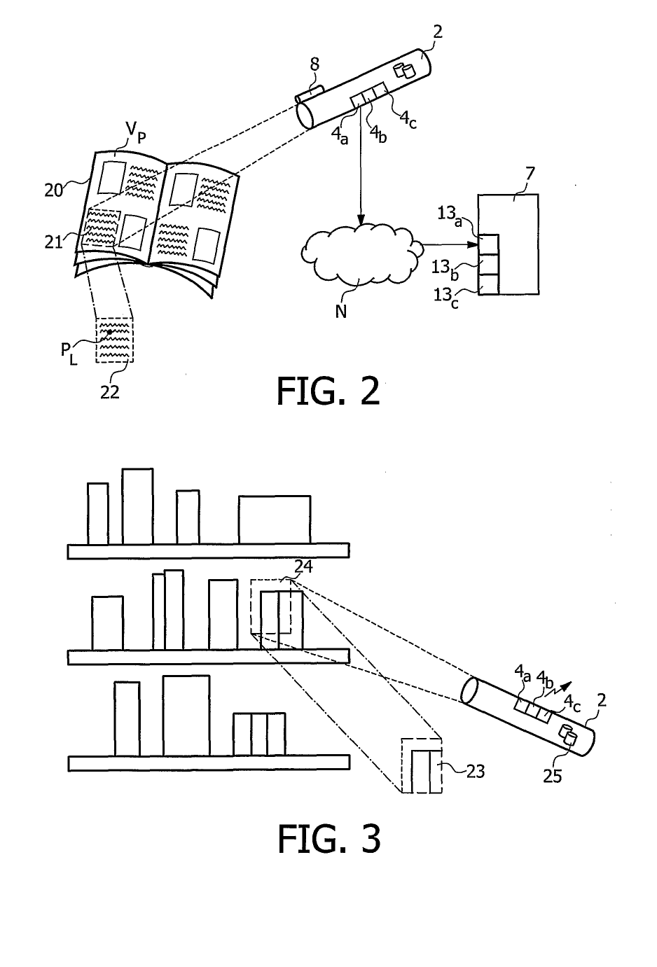

FIG. 2 is a schematic diagram showing a mobile pointing device generating a target area image of a visual presentation.

FIG. 3 is a schematic diagram showing a mobile pointing device generating a target area image of items in a collection.

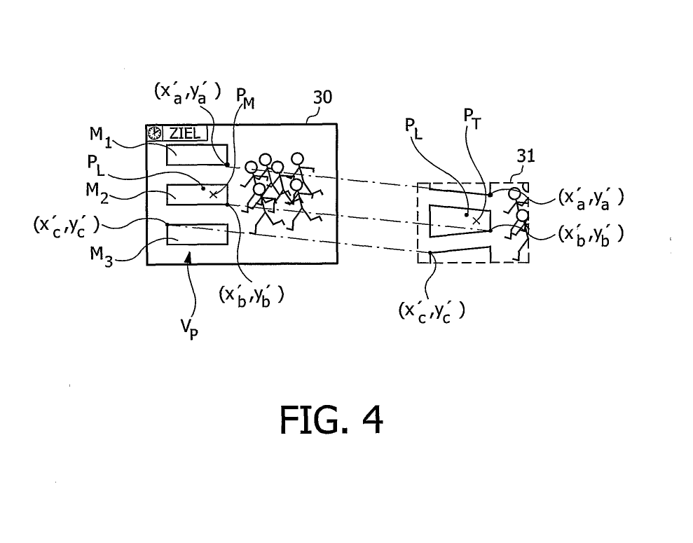

FIG. 4 is a schematic diagram showing a visual presentation and a corresponding target area image in accordance with an embodiment of the present invention.

FIG. 1 shows a local interaction device 7 with a number of wireless interfaces 13ₐ, 13_{b} for communicating with a mobile pointing device 2 which features corresponding interfaces 4ₐ, 4_{b}. One pair of interfaces 4_{b}, 13_{b} serves for local area communication by means of an infrared connection, or more preferably, in a wireless manner, typically implementing a standard such as Bluetooth. This interface pair 4_{b}, 13_{b} is automatically used when the mobile pointing device 2 is within a certain range from the local interaction device 7. Beyond this distance, the interface 5 allows wireless communication using a standard such as GSM or UMTS, or any other telecommunication network or internet. These interfaces 4ₐ, 4_{b}, 13ₐ, 13_{b} can also be used to transmit multimedia, speech etc. These interfaces 4ₐ, 4_{b}, 13ₐ, 13_{b} and a third interface 4_{c}, 13_{c} allow synchronisation of information between the mobile pointing device 2 and the local interaction device 7. To synchronize data between the two devices 2, 7 using the third interface 4_{c}, the user might place the mobile pointing device 2 in a cradle (not shown in the figure) connected in some way to the local interaction device 7. The synchronisation process might start automatically or after first confirming with the user.

The mobile pointing device 2 is used, among others, to create images and transmit these to the local interaction device 7. To this end, the mobile pointing device 2 comprises a camera 3, which is positioned towards the front of the mobile pointing device 2 and generates images of the area in front of the mobile pointing device 2 in the direction of pointing D. The mobile pointing device 2 features an elongated form, so that the direction of pointing D lies along the longitudinal axis of the mobile pointing device 2. The images are sent to the local interaction device 7 by means of a transmitter enclosed in the housing of the mobile pointing device 2 via one of the interfaces 4ₐ, 4_{b}.

A laser light source 8, mounted on the mobile pointing device 2, emits a beam of laser light essentially in the direction of pointing D. In a preferred embodiment, the mobile pointing device 2 features one or more buttons (not shown in the figure). One button can be pressed by the user, for example to confirm that he has made a selection and to transmit the image of the target area. Alternatively, the function of the button might be to activate or deactivate the light source 8 mounted on the mobile pointing device 2, and/or to activate or deactivate the mobile pointing device 2 itself. Equally, the mobile pointing device 2 might be activated by means of a motion sensor incorporated in the mobile pointing device 2. In the example shown, the pointing device 2 has a user interface 6, with a keypad, microphone, loudspeaker etc., so that the user can provide, by means of the interface 4ₐ, 13ₐ, speech or multimedia data for the dialog management system 1 even if he is not in the vicinity of the dialog management system 1. In this case the keypad might fulfil the function of the buttons. Alternatively, the pointing device might be incorporated in a suitable device (not shown in the figure), such as a PDA, mobile phone etc.

The mobile pointing device 2 draws its power from one or more batteries, not shown in the figure. Depending on the power consumption of the mobile pointing device 2, it may be necessary to provide a cradle, also not shown in the figure, into which the mobile pointing device 2 can be placed when not in use, to recharge the batteries. Ideally, this would be the same cradle as that used for synchronisation purposes.

To interpret spoken user input and issue audible output prompts, the local interaction device 7 might feature an audio interface arrangement 5, comprising a microphone 17, loudspeaker 16 and an audio processing block 9. The audio processing block 9 can convert input speech into a digital form suitable for processing by the core dialog engine 11, and can synthesise digital sound output prompts into sound signals for outputting via the loudspeaker 16. Alternatively, the local interaction device 7 might avail of microphone or loudspeaker of a device which it controls, and use these for speech communication with the user.

The local interaction device 7 also features an application interface 10 for handling incoming and outgoing information passed between the local interaction device 7 and a number of applications A₁, A₂, . . . Aₙ. The applications A₁, A₂, . . . Aₙ, shown in the diagram as simple blocks, can in reality be any kind of device or application with which a user would like to interact in some way. In this example, the applications A₁, A₂, . . . Aₙ might include, among others, a television A₁, an internet application such as a personal computer with internet connection A₂, and a store-cupboard management application Aₙ.

The dialog flow in this example consists of communication between the user, not shown in the diagram, and the various applications A₁, A₂, . . . , Aₙ driven by the local interaction device 7. The user issues spoken commands or requests to the local interaction device 7 through a microphone 17. The spoken commands or requests are recorded and digitised in the audio interface block 9, which passes the recorded speech input to a core dialog engine 11. This engine 11 comprises several modules, not shown in detail, for performing the usual steps involved in speech recognition and language understanding to identify spoken commands or user requests, and a dialog controller for controlling the dialog flow and converting the user input into a form suitable understandable by the appropriate application A₁, A₂, . . . , Aₙ.

Should it be necessary to obtain some further information from the user, for example if the spoken commands can not be parsed or understood by core dialog engine 11, or if the spoken commands cannot be applied to any of the applications A₁, A₂, . . . , Aₙ that are active, the core dialog engine 11 generates appropriate requests and forwards these to the audio interface block 9 where they are synthesized to speech and then converted to audible sound by an sound output arrangement 16 such as a loudspeaker.

The usefulness of the dialog management system 1 in situations where the user is not at home and thus removed at some distance from the local interaction device 7, is illustrated in FIG. 2. Here, the user, not shown in the diagram, might be sitting in a doctor's waiting room and might have spotted an interesting article in one of the magazines 20 laid out to read. The article might comprise information about a TV program the user would like to record, or it might concern an interesting website, or might simply be some text or an image which the user might like to show to someone else.

To communicate the information in the article to his local interaction device 7, the user therefore aims his mobile pointing device 2 at a target area 21, i.e. the area covering the article of interest on the page 20 of the magazine. With the aid of a laser point P_{L} generated by a laser light source 8 on the mobile pointing device 2, he can locate the area on the page 20 which he wishes to photograph. The camera 3 in the mobile pointing device 2 generates an image 22 of the target area, and, on pressing a button, the image 22 is automatically transmitted via a telecommunication network N to the receiver 13ₐ of the local interaction device 7. Since the local interaction device 7 is in the user's home and out of the range of the local communication interfaces 4_{b}, 13_{b}, the long distance interfaces 4ₐ, 13ₐ are used to transmit the image 22 to the local interaction device 7, which automatically acknowledges the arrival of new information, carries out processing steps as required in an image processing arrangement 14, here an image processing unit, and stores the image 22 in its internal memory 12.

At home again, the user might like to look at the article again and use the information in some way. To this end, he issues an appropriate spoken command to the local interaction device 7 such as “Show me the image I sent earlier on”. The local interaction device 7 retrieves the image from its local memory 12 and displays it as appropriate. It may use the TV screen if the target area image is large, or it may use a smaller display of another suitable device if the target area image is small. The user can command the local interaction device 7 to deal with the image in a certain way. For example, if the image comprises information about a TV program, the user might say “Record this program tonight”, so that the local interaction device 7 sends the appropriate command to the television A₁. If it is a URL for a website, the user might say “Connect to this internet website”, in which case the local interaction device 7 issues the appropriate commands to the internet application A₂. The image might consist of a recipe which the user would like to add to his collection. In this case he might say “Add this to the store-cupboard application and make sure I have everything I need”. Here, the local interaction device 7 sends the recipe in an appropriate form to the store-cupboard application Aₙ and issues the appropriate inquiries. If the store-cupboard application Aₙ reports that an ingredient is missing or not present in the required amount, this ingredient is automatically placed on the shopping list.

By means of the user interface 6 and the long-distance communication interfaces 4ₐ, 13ₐ, the user can carry out a dialog with the local interaction device, even when far removed from the local interaction device 7, to specify the manner in which the target area image 22 is to be processed. In this way, the user might specify that the information in the target area image 22 is to be used to program a VCR to record the program described in the image 22.

FIG. 3 illustrates another use of the dialog management system 1. Here, the mobile pointing device 2 is being used to record spatial and visual information about items which might be, for example, products on a supermarket shelf, books in a collection, or wares in a warehouse. By aiming the mobile pointing device 2 at a particular item 24, an image 23 of each item 24 can be generated and transmitted to the local interaction device 7 accompanied by spatial information regarding the position of the item 24. The spatial information might be supplied by the mobile pointing device 2 by means of a position sensor, not shown in the diagram, or might be supplied by the user, for example by a spoken description of the item's position. Equipped with suitable image processing capabilities, the image processing arrangement 14 can itself derive spatial information regarding the position of an object 24 by analysing the image of the object 24 and its surroundings.

The local interaction device 7 might be located in the vicinity or might be in an entirely separate location, so that the mobile pointing device 2 uses its long-distance interface 4ₐ to send the image 23 and accompanying spatial information to the appropriate interface 13ₐ of the local interaction device. Alternatively, the user may choose to store the image 23 in the local memory 25 of the mobile pointing device 2 for later retrieval.

The information thus sent to the local interaction device 7 may be also used to train an application A₁, A₂, . . . , Aₙ to recognise images of items, or to locate them upon request.

In a further application of the dialog management system 1, the mobile pointing device 2 can be used to make a selection between a number of user options M 1, M₂, M₃ visually presented on the display 30 of the local interaction device 7 or of an application A₁. FIG. 4 shows a schematic representation of a target area image 31 generated by a mobile pointing device 2 pointed at the visual presentation 4ₐ. The mobile pointing device 2 is aimed at the visual presentation VP from a distance and at an oblique angle, so that the scale and perspective of the options M₁, M₂, M₃ in the visual presentation VP appear distorted in the target area image 31. Regardless of the angle of the mobile pointing device 2 with respect to the visual presentation VP, the target area image 31 is always centred around an image centre point P_{T}. The laser point P_{L} also appears in the target area image 31, and may be a distance removed from the image centre point P_{T}, or might coincide with the image centre point P_{T}. The image processing unit 14 compares the target area image 31 with pre-defined templates to determine the chosen option.

The pre-defined templates can be obtained by an accessing unit 15, for example from an internal memory 12, an external memory 19, or another source such as the internet. Ideally the accessing unit 15 has a number of interfaces allowing access to external data 19, for example the user might provide pre-defined templates stored on a memory medium 19 such as floppy disk, CD or DVD. The templates may also be configured by the user, for example in a training session in which the user specifies the correlation between specific areas on a template with particular functions.

To determine the option selected by the user, the point of intersection P_{T} of the longitudinal axis of the mobile pointing device 2 with the visual presentation VP is located. The point in the template corresponding to the point of intersection P_{T} can then be located to determine the chosen option. To this end, computer vision algorithms using edge- and corner detection methods are applied to locate points in the target area image [(xₐ, yₐ), (x_{b}, y_{b}), (x_{c}, y_{c})] which correspond to points in the template [(xₐ′, yₐ′), (x_{b}′, y_{b}′), (x_{c}′, y_{c}′)] of the visual presentation VP.

Each point can be expressed as a vector e.g. the point (xₐ, yₐ) can be expressed as \vec{v}ₐ. As a next step, a transformation function T_{λ} is developed to map the target area image to the template:

$$f ( λ ) = {\sum }_{i} {\vert {T}_{λ} ( {{v}^{->}}_{i} ) - {{v}^{->}}_{i}^{′} \vert}^{2}$$

where the vector \vec{v}ᵢ represents the coordinate pair (xᵢ, yᵢ) in the target area image, and the vector \vec{v}ᵢ represents the corresponding coordinate pair (x′ᵢ, y′ᵢ) in the template. The parameter set λ, comprising parameters for rotation and translation of the image yielding the most cost-effective solution to the function, can be applied to determine the position and orientation of the mobile pointing device 2 with respect to the visual presentation VP. The computer vision algorithms make use of the fact that the camera 3 within the mobile pointing device 2 is fixed and “looking” in the direction of the pointing gesture. The next step is to calculate the point of intersection of the longitudinal axis of the mobile pointing device 2 in the direction of pointing D with the plane of the visual presentation VP. This point may be taken to be the centre of the target area image P_{T}, or, if the device has a laser pointer, the laser point P_{L} can be used instead. Once the coordinates of the point of intersection have been calculated, it is a simple matter to locate this point in the template of the visual presentation VP, thus determining the option selected by the user.

Although the present invention has been disclosed in the form of preferred embodiments and variations thereon, it will be understood that numerous additional modifications and variations could be made thereto without departing from the scope of the invention. The mobile pointing device used in conjunction with the home dialog system can serve as a universal user interface for controlling applications while at home or away. In short, it can be beneficial whenever an intention of a user can be expressed by pointing, which means that it can be used for essentially any kind of user interface. The small form factor of the mobile pointing device and its convenient and intuitive usage can elevate this simple device to a powerful universal remote control. Its ability to be used to control a multitude of devices, providing access to content items of the devices, as well as allowing for personalization of the device's user interface options, make this a powerful tool. As an alternative to the pen shape, the mobile pointing device could for example also be a personal digital assistant (PDA) with a built-in camera, or a mobile phone with a built-in camera. The mobile pointing device might be combined with other traditional remote control features or with other input modalities such as voice control for direct access to content items of the device to be controlled.

The usefulness of the dialog management system need not be restricted to the applications described herein, for example it may equally find application within a medical environment, or in industry. The mobile pointing device used in conjunction with the local interaction device could make life considerably easier for users who are handicapped or so restricted in their mobility that they are unable to reach the appliances or to operate them in the usual manner.

For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1. A dialog management system (1) for controlling an application (A₁, A₂, . . . , Aₙ), comprising
a mobile pointing device (2) comprising
a camera (3) for generating an image (22, 23, 31) of a target area in the direction (D) in which the mobile pointing device (2) is aimed;
and a transmission interface (4ₐ, 4_{b}) for transmitting the target area image (22, 23, 31) to a local interaction device (7);
and a local interaction device (7) comprising
an audio interface arrangement (5) for detecting and processing speech input and generating and outputting audible prompts;
a core dialog engine (11) for coordinating a dialog flow by interpreting user input and generating output prompts;
an application interface (12) for communication between the dialog management system (1) and the application (A₁, A₂, . . . , Aₙ);
a receiving interface (13ₐ, 13_{b}) for receiving the target area image (22, 23, 31) from the mobile pointing device (2) and
an image processing arrangement (14) for processing the target area image (22, 23, 31).

2. A dialog management system according to claim 1, where the local interaction device (7) comprises an accessing unit (15) for accessing pre-defined templates associated with visual presentations (VP) of user options (M₁, M₂, M₃) for the application (A₁, A₂, . . . , Aₙ) to be controlled and
where the image processing arrangement (14) comprises means for locating the target area or a point (P_{T}) of the target area in a pre-defined template in order to determine a chosen option (M₁, M₂, M₃) in the visual presentation (VP) on which the mobile pointing, device (2) was aimed at while generating the image.

3. A dialog management system according to claim 1, where the local interaction device (7) comprises a display unit (30) for dynamically displaying a visual presentation (VP) of the user options (M₁, M₂, M₃) and/or a visual dialog prompt for the application to be controlled (A₁, A₂, . . . Aₙ) and/or for outputting images to the user.

4. A dialog management system according to claim 1,
where the image processing arrangement (14) comprises means for determining a target point (P_{T}) in the target area image (22, 23, 31) using computer vision algorithms.

5. A dialog management system according to claim 1, where the mobile pointing device (2) comprises a source (8) of a concentrated beam of light attached to the mobile pointing device (2) to show the user a light point (P_{L}) in the visual presentation (22, 23, 31) at which the mobile pointing device (2) is aimed.

6. A dialog management system according to claim 1, where the mobile pointing device (2) comprises a memory medium (25) for storage of target area images.

7. A dialog management system according to claim 1,
where the mobile pointing device (2) comprises an interface (4ₐ) for transmitting and/or receiving speech and media data and where the local interaction device (7) comprises an interface (13ₐ) for receiving and/or transmitting speech and media data over the communication network.

8. A mobile pointing device (2) for a speech dialog management system (1) according to claim 1 comprising
a camera (3) for generating an image (22, 23, 31) of a target area in the direction (D) in which the mobile pointing device (2) is aimed;
and a transmission interface (4ₐ, 4_{b}) for transmitting the target area image (22, 23, 31) to a local interaction device (7).

9. A local interaction device (7) for a speech dialog management system (1) according to claim 1 comprising
an audio interface arrangement (5) for detecting and processing speech input and generating and outputting audible prompts;
a sound output arrangement (16) for outputting an audible prompt;
a core dialog engine (11) for coordinating a dialog flow by interpreting user input and generating output prompts;
an application interface (12) for communication between the dialog management system (7) and the application (A₁, A₂, . . . , Aₙ);
a receiving interface (13ₐ, 13_{b}) for receiving the target area image (22, 23, 31) from a mobile pointing device (2) and
an image processing arrangement (14) for processing the target area image (22, 23, 31).

10. A method for driving a dialog management system (1) for controlling an application by spoken dialog,
which method comprises an additional step of aiming a mobile pointing device (2) comprising a camera (3) at an specific object (20, 24, 30), generating an image (22, 23, 31) of a target area aimed at by the mobile pointing device (2), transmitting the target area image (22, 23, 31) to a local interaction device (7) of the dialog management system (1) and processing the target area image (22, 23, 31) in order to derive control information for controlling the application (A₁, A₂, . . . , Aₙ).

11. A method according to claim 10, where the object (30) at which the mobile pointing device (2) is aimed comprises a user option (M₁, M₂, M₃) for the application (A₁, A₂, . . . Aₙ) to be controlled and the target area image (31) is analysed to determine the chosen option.

12. A method according to claim 10, where the target area image (23) is used to train the dialog management system (1).

13. A method according to claim 12, where the target area image (23) is used to derive information for the dialog management system (1) about the location of specific objects (24).
